(19) United States
(12) Patent Application Publication
(10) Pub. No.: US 2012/0212606 A1
(43) Pub. Date: Aug. 23, 2012

(54) IMAGE PROCESSING METHOD AND IMAGE PROCESSING APPARATUS FOR DEALING WITH PICTURES FOUND BY LOCATION INFORMATION AND ANGLE INFORMATION

(76) Inventor: Min-Hung Chien, Taichung City (TW)

(21) Appl. No.: 13/031,241

(22) Filed: Feb. 20, 2011

(51) Int. Cl. H04N 7/18

(52) U.S. Cl. 348/135; 348/E07.085

(57) ABSTRACT

An image processing method includes: determining target location information and target angle information; and utilizing a search module for obtaining selected pictures from a plurality of candidate pictures by referring to location information and angle information of each of the candidate pictures, the target location information, and the target angle information. An image processing apparatus includes a determination module and a search module. The determination module is arranged to determine target location information and target angle information. The search module is coupled to the determination module, and implemented for obtaining selected pictures from a plurality of candidate pictures by referring to location information and angle information of each of the candidate pictures, the target location information, and the target angle information.

### BACKGROUND

The disclosed embodiments of the present invention relate to image processing, and more particularly, to an image processing method and image processing apparatus for dealing with pictures found by location information and angle information.

The conventional 2-dimensional (2D) display is to show a single picture on a display screen. However, with the development of the science and technology, users are pursuing more real image outputs rather than high quality image outputs. In other words, the users desire to have improved viewing experience of the 2D pictures.

In addition to the image contents, the 2D picture may be defined to include auxiliary information. Thus, an innovative 2D image processing scheme which can properly uses the auxiliary information to provide the user with an emotional playback is needed.

### SUMMARY

In accordance with exemplary embodiments of the present invention, an image processing method and image processing apparatus for dealing with pictures found by location information and angle information are proposed to solve the above-mentioned problem.

According to a first aspect of the present invention, an exemplary image processing method is disclosed. The exemplary image processing method includes: determining target location information and target angle information; and utilizing a search module for obtaining selected pictures from a plurality of candidate pictures by referring to location information and angle information of each of the candidate pictures, the target location information, and the target angle information.

According to a second aspect of the present invention, an exemplary image processing apparatus is disclosed. The exemplary image processing apparatus includes a determination module and a search module. The determination module is arranged to determine target location information and target angle information. The search module is coupled to the determination module, and implemented for obtaining selected pictures from a plurality of candidate pictures by referring to location information and angle information of each of the candidate pictures, the target location information, and the target angle information.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating an image processing apparatus according to an exemplary embodiment of the present invention.

FIG. 2 is a diagram illustrating an exemplary embodiment of determining selected pictures among a plurality of candidate pictures.

FIG. 3 is a diagram illustrating the playback of target pictures in a time-domain playback mode.

FIG. 4 is a diagram illustrating the playback of target pictures in an angle-domain playback mode.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is electrically connected to another device, that connection may be through a direct electrical connection, or through an indirect electrical connection via other devices and connections.

Regarding the generation of a 2D picture, auxiliary information, such as time information, location information, angle information, etc., may be obtained/calculated and then stored in the same file of the 2D picture. For example, a digital camera is equipped with a locator, such as a global positioning system (GPS) receiver, and is also devised to support a multi-picture format (MPF). Therefore, when a scene is shot by the digital camera, the location where the digital camera is located, the angle of a shot direction of the digital camera, and the time when the user presses the shutter button on the digital camera are easily known and encoded in the file of the captured picture. Therefore, the present invention proposes an innovative image processing scheme for providing the user with a more emotional playback of the 2D pictures each having the aforementioned auxiliary information. Further details are described as follows.

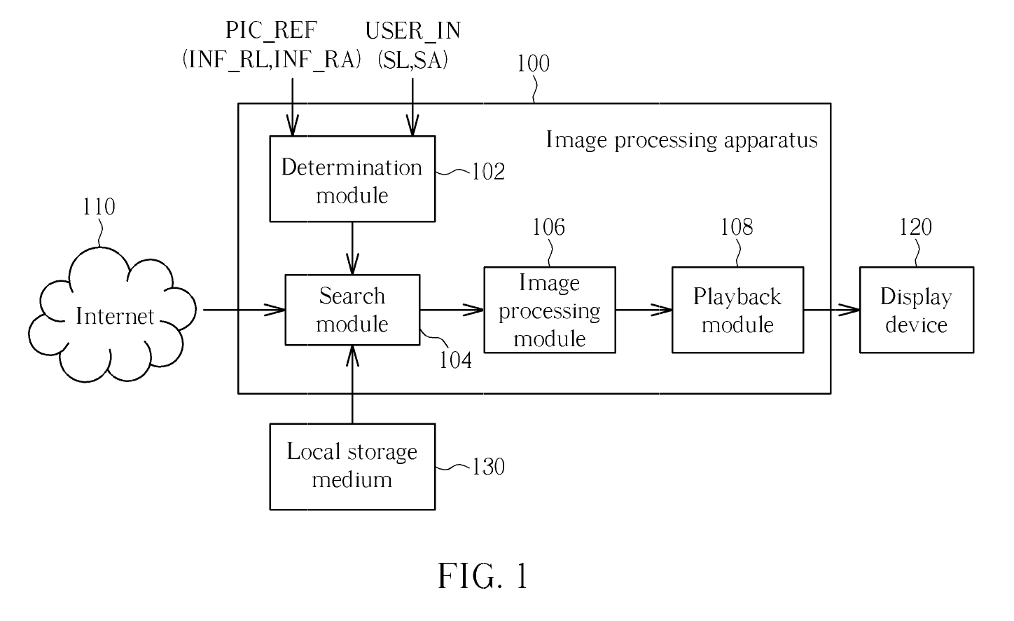

FIG. 1 is a block diagram illustrating an image processing apparatus according to an exemplary embodiment of the present invention. The exemplary image processing apparatus 100 includes, but is not limited to, a determination module 102, a search module 104, an image processing module 106, and a playback module 108. In one exemplary implementation, all of the determination module 102, the search module 104, the image processing module 106, and the playback module 108 may be implemented by hardware. In another exemplary embodiment, at least one of the determination module 102, the search module 104, the image processing module 106, and the playback module 108 may be implemented by a processor which executes a designated program code for achieving the desired functionality. The determination module 102 is arranged to determine target location information INF_TL and target angle information INF_TA used by the search module 104. In one exemplary implementation, the determination module 102 receives a reference picture PIC_REF, and utilizes location information INF_RL and angle information INF_RA of the reference picture PIC_REF as the target location information INF_TL and the target angle information INF_TA, respectively. For example, when a user wants to view the reference picture PIC_REF, the user may selects the reference picture PIC_REF and inputs the reference picture PIC_REF to the image processing apparatus for image display. Thus, the determination module 102 sets the target location information INF_TL and the target angle information INF_TA according to the auxiliary information embedded in the reference picture PIC_REF. In another exemplary implementation, the determination module 102 receives a user control input USER_IN including a user-defined location setting SL and a user-defined angle setting SA, directly sets the target location information INF_TL by the user-defined location setting SL, and directly sets the target angle information INF_TA by the user-defined angle setting SA. That is, the location indicated by the user-defined location setting SL will be identical to the location indicated by the user-defined location setting SL, and the angle indicated by the user-defined angle setting SA will be identical to the angle indicated by the user-defined angle setting SA. The user control input USER_IN may be generated through any man-machine interface/user interface.

In this exemplary embodiment, the search module 104 is equipped with angle calculation capability and picture of interest (POI) selection capability, and is therefore arranged to obtain selected pictures (i.e., pictures of interest) from a plurality of candidate pictures by referring to location information and angle information of each of the candidate pictures, the target location information INF_TL, and the target angle information INF_TA. As shown in FIG. 1, the search module 104 may be coupled to the Internet 110, and the candidate pictures are therefore accessible through the Internet 110. Besides, the search module 104 may also access the candidate pictures stored in a local storage medium 130 (e.g., a hard disk, an optical disc, or a memory card). By way of example, but not limitation, the search module 104 may use a search keyword, such as “Eiffel” or “Eiffel Tower”, to roughly find the candidate pictures with file names having the wanted search keyword included therein. However, this is for illustrative purposes only. For example, in an alternative design, all of the stored pictures accessible to the search module 104 may be regarded as the candidate pictures. The target location information INF_TL and the target angle information INF_TA determined by the determination module 102 will be used by the search module 104 for obtaining selected pictures from the candidate pictures. Further details are described as follows.

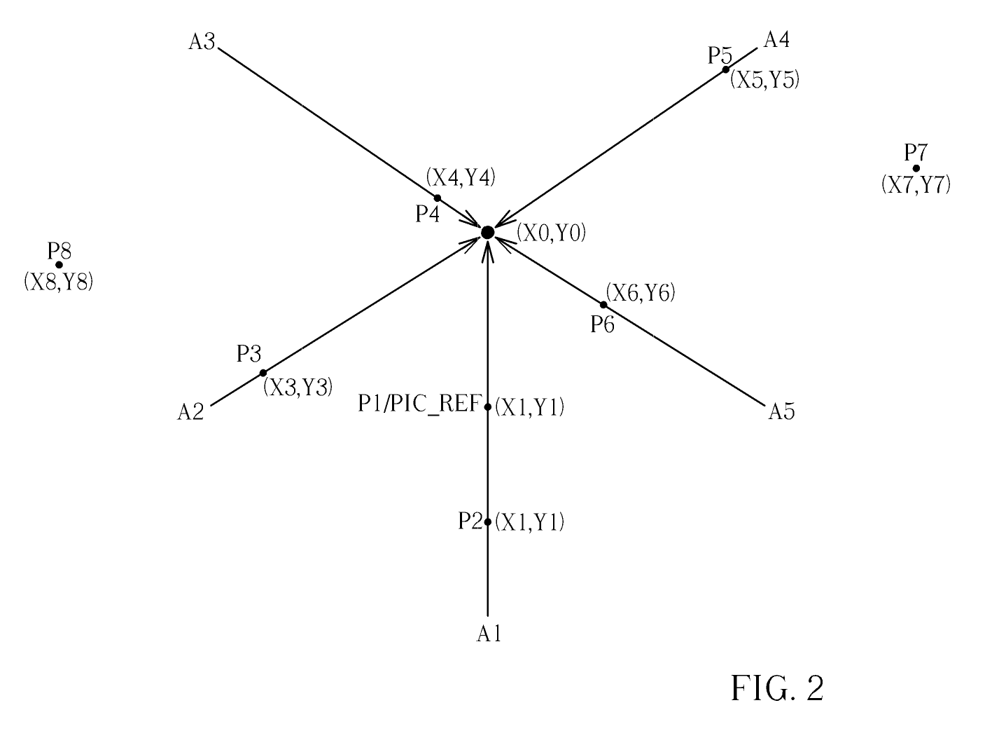

In this exemplary embodiment, the image processing apparatus 100 may operate in a time-domain playback mode or an angle-domain playback mode. When the image processing apparatus 100 operates in the time-domain playback mode, the selected pictures found by the search module 104 would have the same angle indicated by the target angle information INF_TA. Please refer to FIG. 2, which is a diagram illustrating an exemplary embodiment of determining selected pictures among a plurality of candidate pictures. Suppose that a target object (e.g., the Eiffel tower) is located at the location (X0,Y0), the target location information INF_TL indicates the location (X1,Y1), and the target angle information INF_TA indicates the angle A1. As shown in FIG. 2, there are eight candidate pictures P1-P8 shot at different locations, respectively. By way of example, but not limitation, each of the candidate pictures P1-P8 has a file name with the above-mentioned search keyword “Eiffel” or “Eiffel Tower” included therein. It should be noted that, in this example shown in FIG. 2, only one candidate picture is shot at one location shown in FIG. 2. However, this is meant to be taken as a limitation of the present invention. That is, as more than one picture is allowed to be shot at the same location by the same digital camera or different digital cameras, the pictures captured at the same location may all become the candidate pictures when accessible to the search module 104.

As shown in FIG. 2, the candidate picture P7 is shot at a location (X7,Y7) far from the location (X1,Y1) indicated by the target location information INF_TL, and the candidate picture P8 is also shot at a location (X8,Y8) far from the location (X1,Y1) indicated by the target location information INF_TL. Though the file names of the candidate pictures P7 and P8 may have the desired search keyword “Eiffel” or “Eiffel Tower” included therein or the candidate pictures P7 and P8 are both accessible to the search module 104, it is possible that each of the candidate pictures P7 and P8 has no Eiffel tower image (i.e., an image of the target object) included therein or has an unidentifiable Eiffel tower image included therein. Therefore, the search module 104 does not classify the candidate pictures P7 and P8 as the selected pictures. Regarding the candidate pictures P3-P6, these pictures have angles A2-A5 different from the angle A1 indicated by the target angle information INF_TA. Thus, the search module 104 does not classify the candidate pictures P3-P6 as the selected pictures. The candidate pictures P1 and P2 are respectively shot at locations (X1,Y1) and (X2,Y2) which are close to or identical to the location (X1,Y1) indicated by the target location information INF_TL; additionally, each of the candidate pictures P1 and P2 has the angle A1 indicated by the target angle information INF_TA. Thus, the search module 104 classifies the candidate pictures P1 and P2 as the selected pictures found using the target location information INF_TL and the target angle information INF_TA. It should be noted that the candidate picture P1 may be the aforementioned reference picture PIC_REF when the reference picture PIC_REF is used to set the target location information INF_TL and the target angle information INF_TA. Therefore, the search module 104 classifies the candidate picture P2 as one selected picture found using the target location information INF_TL and the target angle information INF_TA.

When the image processing apparatus 100 operates in the angle-domain playback mode, the selected pictures found by the search module 104 would have different angles to meet the requirement of 360-degree animation playback. Please refer to FIG. 2 again. Similarly, as the candidate picture P7 is shot at the location (X7,Y7) far from the location (X1,Y1) indicated by the target location information INF_TL, and the candidate picture P8 is also shot at the location (X8,Y8) far from the location (X1,Y1) indicated by the target location information INF_TL. Therefore, the search module 104 does not classify the candidate pictures P7 and P8 as the selected pictures. In a case where the reference picture PIC_REF is used to set the target location information INF_TL and the target angle information INF_TA, the candidate pictures P3-P6 with angles A2-A5 different from the angle A1 indicated by the target angle information INF_TA may be selected by the search module 104 as selected pictures. In another case where the user control input USER_IN is used to directly set the target location information INF_TL and the target angle information INF_TA, candidate pictures P3-P6 and one of the candidate pictures P1 and P2 may be selected by the search module 104 as the selected pictures. In other words, in one exemplary implementation, the selected pictures may include candidate pictures P1 and P3-P6; however, in another exemplary implementation, the selected pictures may include candidate pictures P2 and P3-P6.

Briefly summarized, no matter how the search module 104 determines if a picture should be qualified as a selected picture, the spirit of the present invention is obeyed when the search module 104 checks the location information and the angle information to search for the selected picture.

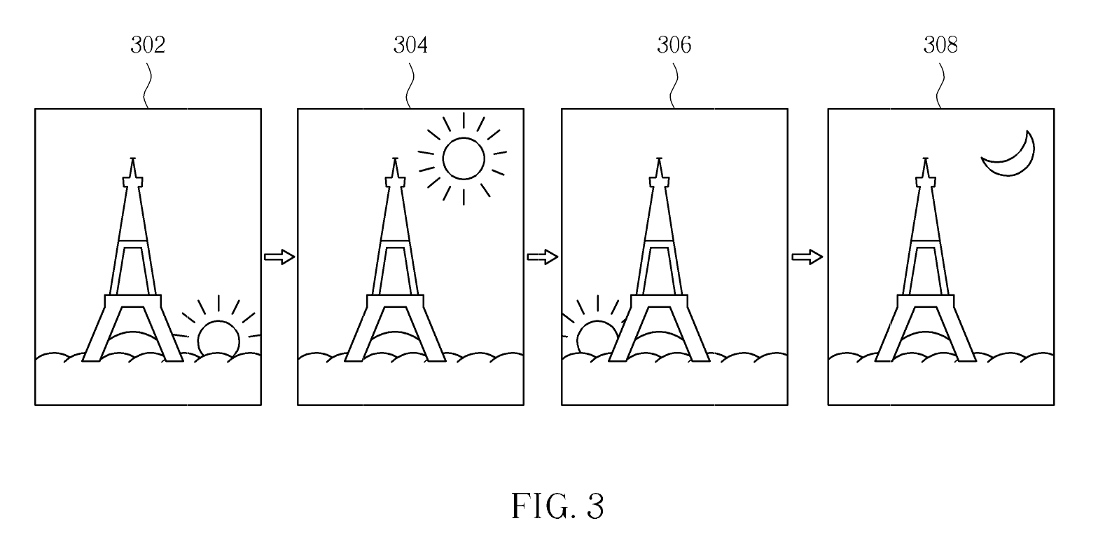

After the selected pictures are obtained by the search module 104, the selected pictures may be used for image display or other purpose. In this exemplary embodiment, target pictures derived from the selected pictures may be displayed for providing the user with improved viewing experience. More specifically, in a case where the time-domain playback mode is enabled, the playback module 108 drives a display device 120 to automatically and sequentially display target pictures according to time information of each of the target pictures. Please refer to FIG. 3, which is a diagram illustrating the playback of target pictures in the time-domain playback mode. In this example, four target pictures 302-306 are derived from selected pictures found by the search module 104, and the time information of the target pictures 302-306 indicates that the target picture 302 is shot at sunrise, the target picture 304 is shot at noon, the target picture 306 is shot at sunset, and the target picture 308 is shot at night. Therefore, the playback module 108 drives the display device 120 to show the target pictures 302-306 sequentially. That is, the target pictures 302-306 have the same angle and are displayed according to the time relationship. In this way, the user may view different pictures showing the status of a target object (e.g., the Eiffel tower) at different time points, and accordingly has improved viewing experience. It should be noted that when the reference picture PIC_REF is used for setting the target location information INF_TL and the target angle information INF_TA, one of the target pictures 302-306 shown in FIG. 3 may be derived from the reference picture PIC_REF.

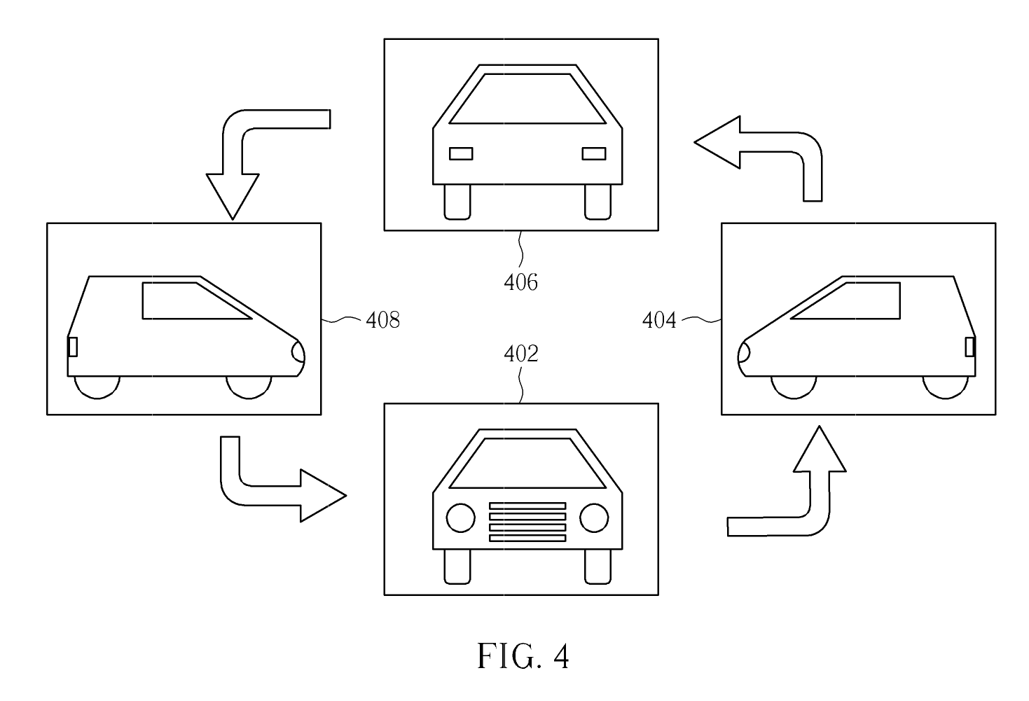

In another case where the angle-domain playback mode is enabled, the playback module 108 drives the display device 120 to automatically and sequentially display target pictures according to angle information of each of the target pictures. Please refer to FIG. 4, which is a diagram illustrating the playback of target pictures in the angle-domain playback mode. In this example, four target pictures 402-408 are derived from selected pictures found by the search module 104, and the angle information of the target pictures 402-408 indicates that the target picture 402 is a font view of a target object (e.g., a car), the target picture 404 is right-side view of the target object, the target picture 406 is a rear view of the target object, and the target picture 408 is a left-side view of the target object. Therefore, the playback module 108 drives the display device 120 to show the target pictures 402-408 sequentially. That is, the target pictures 402-408 have different angles and are displayed according to the angle relationship. In this way, the display device 120 will automatically present a 360-degree animation of the target object for the user, and the user has improved viewing experience accordingly. It should be noted that when the reference picture PIC_REF is used for setting the target location information INF_TL and the target angle information INF_TA, one of the target pictures 402-408 may be derived from the reference picture PIC_REF.

To provide the user with better viewing experience in the time-domain playback mode or the angle-domain playback mode, the image processing apparatus 100 may process the selected pictures found by the search module 104 before the selected pictures are fed into the following playback module 108. Therefore, the image processing module 106 disposed between the search module 104 and the playback module 108 may be enabled. It should be noted that the image processing module 106 may be an optional component. That is, the image processing module 106 may be omitted without departing from the spirit of the present invention.

In a case where the reference picture PIC_REF is used to set the target location information INF_TL and the target angle information INF_YA, the image processing module 106 shown in FIG. 1 is arranged to perform a predetermined image processing operation upon the selected pictures and the reference picture PIC_REF. Regarding a first exemplary implementation, the image processing module 106 may perform the predetermined image processing operation for comparing image sizes of a target object within the selected pictures and the reference picture and accordingly generating a comparison result, and selectively discarding at least one of the selected pictures according to the comparison result. For example, the reference picture PIC_REF may be generated according to one camera's zoom setting, whereas the selected picture P2 found by the search module 104 in the time-domain playback mode may be generated according to another camera's zoom setting. Therefore, the image sizes of the target object (e.g., the Eiffel tower) within the selected picture P2 and the reference picture PIC_REF may be different from each other. If the discrepancy between the image sizes of the target object within the selected picture P2 and the reference picture PIC_REF exceeds a predetermined threshold (e.g., the image size of the target object within the selected picture P2 is far greater or far smaller than the image size of the target object within the reference picture PIC_REF), the selected picture P2 is discarded and will not be regarded as a target picture to be displayed on the display device 120. Similarly, the selected pictures P3-P6 found by the search module 104 in the angle-domain playback mode may be generated according to different cameras' zoom settings. Therefore, the image sizes of the target object (e.g., the Eiffel tower) within the selected pictures P3-P6 and the reference picture PIC_REF may be different from each other. If the discrepancy between the image sizes of the target object within at least one specific selected picture of the selected pictures P3-P6 and the reference picture PIC_REF exceeds a predetermined threshold, the at least one specific selected picture is discarded and will not be regarded as a target picture to be displayed on the display device 120.

In a second exemplary implementation, the image processing module 106 may perform the predetermined image processing operation for adjusting at least one of the selected pictures and the reference picture such that image sizes of a target object within the selected pictures and the reference picture are substantially identical to each other. For example, upon detecting the discrepancy between the image sizes of the target object within the selected picture P2 found by the search module 104 in the time-domain playback mode and the reference picture PIC_REF, the image processing module 106 is operative to adjust the selected picture P2 for making the adjusted image size of the target object (e.g., the Eiffel tower) within the selected picture P2 is substantially identical to the image size of the target object (e.g., the Eiffel tower) within the reference picture PIC_REF. Similarly, upon detecting the discrepancy between the image sizes of the target object within at least one specific selected picture of the selected pictures P3-P6 found by the search module 104 in the angle-domain playback mode and the reference picture PIC_REF, the image processing module 106 is operative to adjust the at least one specific selected picture for making the adjusted image size of the target object within the specific selected picture is substantially identical to the image size of the target object within the reference picture PIC_REF.

In a third exemplary implementation, the image processing module 106 may perform the predetermined image processing operation for creating an interpolated picture according to two specific pictures among the selected pictures and the reference picture, wherein an angle of the interpolated picture is between angles of the two specific pictures. For example, the target picture 402 is the reference picture PIC_REF, the target picture 406 may be a selected picture found by the search module 104 in the angle-domain playback mode, and each of the target pictures 404 and 408 may be an interpolated picture generated by processing the available pictures (i.e., 402 and 406) corresponding to the different angles. Alternatively, more target pictures may be obtained by creating one or more interpolated pictures according to the available pictures (e.g., 402-408). This also obeys the spirit of the present invention.

In another case where the user control input USER_IN, instead of the reference picture PIC_REF, is used to set the target location information INF_TL and the target angle information INF_YA, the image processing module 106 shown in FIG. 1 is arranged to perform a predetermined image processing operation upon the selected pictures. In a first exemplary implementation, the image processing module 106 may perform the predetermined image processing operation for comparing image sizes of a target object within the selected pictures and accordingly generating a comparison result, and selectively discarding at least one of the selected pictures according to the comparison result. For example, the selected picture P1 found by the search module 104 in the time-domain playback mode may be generated according to one camera's zoom setting, whereas the selected picture P2 found by the search module 104 in the time-domain playback mode may be generated according to another camera's zoom setting. Therefore, the image sizes of the target object (e.g., the Eiffel tower) within the selected pictures P1 and P2 may be different from each other. If the discrepancy between the image sizes of the target object within the selected pictures P1 and P2 exceeds a predetermined threshold (e.g., the image size of the target object within the selected picture P1 is far greater or far smaller than the image size of the target object within the selected picture P2), one of the selected pictures P1 and P2 is discarded and will not be regarded as a target picture to be displayed on the display device 120. Similarly, the selected pictures P1 and P3-P6 (or P2 and P3-P6) found by the search module 104 in the angle-domain playback mode may be generated according to different cameras' zoom settings. Therefore, the image sizes of the target object (e.g., the Eiffel tower) within the selected pictures P1 and P3-P6 (or P2 and P3-P6) may be different from each other. If the discrepancy between the image sizes of the target object within at least one specific selected picture of the selected pictures P1 and P3-P6 (or P2 and P3-P6) and remaining selected pictures exceeds a predetermined threshold, the at least one specific selected picture is discarded and will not be regarded as a target picture to be displayed on the display device 120.

In a second exemplary implementation, the image processing module 106 may perform the predetermined image processing operation for adjusting at least one of the selected pictures such that image sizes of a target object within the selected pictures are substantially identical to each other. For example, upon detecting the discrepancy between the image sizes of the target object within the selected pictures P1 and P2 found by the search module 104 in the time-domain playback mode, the image processing module 106 is operative to adjust one of the selected pictures P1 and P2 for making the adjusted image size of the target object (e.g., the Eiffel tower) within one of the selected pictures P1 and P2 is substantially identical to the image size of the target object (e.g., the Eiffel tower) within the other of the selected pictures P1 and P2. Similarly, upon detecting the discrepancy between the image sizes of the target object within at least one specific selected picture of the selected pictures P1 and P3-P6 (or P2 and P3-P6) found by the search module 104 in the angle-domain playback mode and remaining selected pictures of the selected pictures P1 and P3-P6 (or P2 and P3-P6), the image processing module 106 is operative to adjust the at least one specific selected picture for making the adjusted image size of the target object within the at least one specific selected picture is substantially identical to the image sizes of the target object within the remaining selected pictures.

In a third exemplary implementation, the image processing module 106 may perform the predetermined image processing operation for creating an interpolated picture according to two specific pictures among the selected pictures, wherein an angle of the interpolated picture is between angles of the two specific pictures. For example, the target pictures 402 and 406 may be selected pictures found by the search module 104 in the angle-domain playback mode, and each of the target pictures 404 and 408 may be an interpolated picture generated by processing the available selected pictures (i.e., 402 and 406) corresponding to the different angles. Alternatively, more target pictures may be obtained by creating one or more interpolated pictures according to the available selected pictures (e.g., 402-408). This also obeys the spirit of the present invention.

Those skilled in the art will readily observe that numerous modifications and alterations of the device and method may be made while retaining the teachings of the invention.

What is claimed is:

1. An image processing method, comprising:
determining target location information and target angle information; and
utilizing a search module for obtaining selected pictures from a plurality of candidate pictures by referring to location information and angle information of each of the candidate pictures, the target location information, and the target angle information.

2. The image processing method of claim 1, wherein determining the target location information and the target angle information comprises:
receiving a reference picture; and
utilizing location information and angle information of the reference picture as the target location information and the target angle information, respectively.

3. The image processing method of claim 2, wherein the selected pictures have a same angle indicated by the target angle information.

4. The image processing method of claim 3, further comprising:
driving a display device to automatically and sequentially display target pictures according to time information of each of the target pictures;
wherein one target picture is derived from the reference picture, and remaining target pictures are derived from the selected pictures.

5. The image processing method of claim 2, wherein the selected pictures have different angles.

6. The image processing method of claim 5, further comprising:
driving a display device to automatically and sequentially display target pictures according to angle information of each of the target pictures;
wherein one target picture is derived from the reference picture, and remaining target pictures are derived from the selected pictures.

7. The image processing method of claim 2, further comprising:
performing a predetermined image processing operation upon the selected pictures and the reference picture.

8. The image processing method of claim 7, wherein the predetermined image processing operation comprises:
comparing image sizes of a target object within the selected pictures and the reference picture, and accordingly generating a comparison result; and
selectively discarding at least one of the selected pictures according to the comparison result.

9. The image processing method of claim 7, wherein the predetermined image processing operation comprises:
adjusting at least one of the selected pictures and the reference picture such that image sizes of a target object within the selected pictures and the reference picture are substantially identical to each other.

10. The image processing method of claim 7, wherein the predetermined image processing operation comprises:
creating an interpolated picture according to two specific pictures among the selected pictures and the reference picture, wherein an angle of the interpolated picture is between angles of the two specific pictures.

11. The image processing method of claim 1, wherein determining the target location information and the target angle information comprises:
receiving a user control input including a user-defined location setting and a user-defined angle setting;
setting the target location information by the user-defined location setting; and
setting the target angle information by the user-defined angle setting.

12. The image processing method of claim 11, wherein the selected pictures have a same angle indicated by the target angle information.

13. The image processing method of claim 12, further comprising:
driving a display device to automatically and sequentially display target pictures according to time information of each of the target pictures;
wherein each of the target pictures is derived from the selected pictures.

14. The image processing method of claim 11, wherein the selected pictures have different angles.

15. The image processing method of claim 14, further comprising:
driving a display device to automatically and sequentially display target pictures according to angle information of each of the target pictures;
wherein each of the target pictures is derived from the selected pictures.

16. The image processing method of claim 11, further comprising:
performing a predetermined image processing operation upon the selected pictures.

17. The image processing method of claim 16, wherein the predetermined image processing operation comprises:
comparing image sizes of a target object within the selected pictures, and accordingly generating a comparison result; and
selectively discarding at least one of the selected pictures according to the comparison result.

18. The image processing method of claim 16, wherein the predetermined image processing operation comprises:
adjusting at least one of the selected pictures and the reference picture such that image sizes of a target object within the selected pictures are substantially identical to each other.

19. The image processing method of claim 16, wherein the predetermined image processing operation comprises:
creating an interpolated picture according to two specific pictures among the selected pictures, wherein an angle of the interpolated picture is between angles of the two specific pictures.

20. An image processing apparatus, comprising:
a determination module, arranged to determine target location information and target angle information; and
a search module, coupled to the determination module, for obtaining selected pictures from a plurality of candidate pictures by referring to location information and angle information of each of the candidate pictures, the target location information, and the target angle information.

21. The image processing apparatus of claim 20, wherein the determination module receives a reference picture, and utilizes location information and angle information of the reference picture as the target location information and the target angle information, respectively.

22. The image processing apparatus of claim 21, wherein the selected pictures obtained by the search module have a same angle indicated by the target angle information.

23. The image processing apparatus of claim 22, further comprising:
a playback module, coupled to the search module, for driving a display device to automatically and sequentially display target pictures according to time information of each of the target pictures;
wherein one target picture is derived from the reference picture, and remaining target pictures are derived from the selected pictures.

24. The image processing apparatus of claim 21, wherein the selected pictures obtained by the search module have different angles.

25. The image processing apparatus of claim 24, further comprising:
a playback module, coupled to the search module, for driving a display device to automatically and sequentially display target pictures according to angle information of each of the target pictures;
wherein one target picture is derived from the reference picture, and remaining target pictures are derived from the selected pictures.

26. The image processing apparatus of claim 20, wherein the determination module receives a user control input including a user-defined location setting and a user-defined angle setting, sets the target location information by the user-defined location setting, and sets the target angle information by the user-defined angle setting.

27. The image processing apparatus of claim 26, wherein the selected pictures obtained by the search module have a same angle indicated by the target angle information.

28. The image processing apparatus of claim 27, further comprising:
a playback module, coupled to the search module, for driving a display device to automatically and sequentially display target pictures according to time information of each of the target pictures;
wherein each of the target pictures is derived from the selected pictures.

29. The image processing apparatus of claim 26, wherein the selected pictures obtained by the search module have different angles.

30. The image processing apparatus of claim 29, further comprising:
a playback module, coupled to the search module, for driving a display device to automatically and sequentially display target pictures according to angle information of each of the target pictures;
wherein each of the target pictures is derived from the selected pictures.
